(19) United States
(12) Patent Application Publication
(10) Pub. No.: US 2014/0120363 A1
(43) Pub. Date: May 1, 2014

(54) Flexible Laminating Ring Covering

(71) Applicant: KING'S METAL FIBER TECHNOLOGIES CO., LTD., Taichung (TW)

(72) Inventor: Guido HEIRBAUT, Taipei (TW)

(73) Assignee: KING'S METAL FIBER TECHNOLOGIES CO., LTD., Taichung (TW)

(21) Appl. No.: 13/660,123

(22) Filed: Oct. 25, 2012

(51) Int. Cl. B32B 15/01; B23P 11/00; B32B 5/26

(52) U.S. Cl. 428/605; 29/428; 29/505

(57) ABSTRACT

The present invention provides a material which comprises a first knitted steel fiber layer, and a second steel fiber layer, in which the first knitted steel fiber layer and the second steel fiber layer is interlocked to form the material. The orientation of the layer being selected in that if the first knitted steel fiber layer in unlocked state rolls up on one side in a first dimension and the second steel fiber layer in unlocked state rolls up in on one side in this same first dimension, the orientation of the layers being contacting each other when the layers are interlocked, to her compensate the forces within the materials.

### FIELD OF THE INVENTION

The invention relates to steel layer based materials, the methods of manufacturing such materials and use thereof in glass processing.

### BACKGROUND OF THE INVENTION

The invention relates to steel materials suitable for use in glass processing, more particular windshield production for vehicles such as cars, more specifically for use as a flexible laminating ring covering used in such production.

One of the materials used today in most windshields production is a narrow woven tape, whereby some of these tapes are compressed to flatten the surface. Such woven tapes have a high density. This makes them less flexible. Flexibility is needed in the corners of the ring. Because of the high density the tapes are not very compressible. This can result in small marks on the glass. After heating, the material will expand. This can result in an uneven surface. To solve this problem the ring must be remounted.

An alternative material is a needle-punched material with or without a woven scrim. However such needle-punched materials with a woven scrim have the same mounting difficulties as woven tapes. Moreover the lifetime is short. Once the top layer of fiber disappears the tape will scratch the glass.

Yes an alternative material is a knitted strip. However the mounting of a knitted strip is very difficult because the material curls and again the lifetime is limited

### AIM OF THE INVENTION

The aim of the invention is to provide for materials suitable for use in glass processing like windshield production as explained above.

### SUMMARY OF THE INVENTION

In a first aspect of the invention a material is proposed which comprises a first knitted steel fiber layer, more in particular the material being so adapted or selected that at least a piece of the material remains substantially fiat if in rest, hence the problem of curls is cured.

In a first embodiment thereof the material comprises a second steel fiber layer, wherein said first and second fiber layer, being interlocked to form the material, more in particular the layer orientation being selected in that if the first layer in unlocked state rolls up on one side in a first dimension and the second layer in unlocked state rolls up in on one side in this same first dimension, the orientation of the layers being so selected that the opposites of these one sides of said first and second layer contacting each other when the layers are interlocked, to thereby compensate the forces within the materials.

In a further embodiment thereof the second steel fiber layer is also knitted steel fiber layer. Alternatively the second steel fiber layer is a fiber web layer or needle-punched fiber layer in yet another alternative the second steel fiber layer is a woven steel fiber layer.

In a second embodiment (which is combinable with the first embodiment) one side of the first and second layer has a less rough surface than the other side thereof, and the orientation of the layers being so selected that the roughest sides of said first and second layer contacting each other when the layers are interlocked, to thereby avoid marks on the glass when the material is used in processing thereof.

One of the techniques to interlock said first and second layer is to needle-punched them together to form the material.

In an alternative embodiment instead of a multi-layer approach the first knitted steel fiber layer is selected to be a double bed (also denoted double jersey) with its intrinsic curl free properties and softer sides.

In all the above embodiments one or more of the steel fiber layer is made of stainless steel.

Note that the above single or multi-layer structures can be combined to form even more complicated structure if needed. Further in between the layers of the multi-layer structures additional layers can be added. Therefore the material can comprise of three layers of which one or two are knitted while the other can be a web or a need punched fiber web or a woven fabric. Such web can be added on the cuter side to reduce the roughness of the surface or in between the layers for instance to make the interconnection stronger. The material can even comprises of four layers with a web at the outer side and one web in between.

In a second aspect of the invention the use of the material as discussed above in (laminate) glass processing, in particular windshield production, more in particular as covering ring, is disclosed.

In a third aspect of the invention a manufacturing method of a material is disclosed, the material being so adapted that at least a piece of the material remains substantially flat in rest, the method comprising the step of obtaining a first knitted steel fiber layer, the step of obtaining a second steel fiber layer; and a step of interlocking said first and second layer.

In an embodiment thereof the method further comprises the step of determining on which side the first layer rolls up in unlocked state, the step of determining on which side the second layer rolls up in unlocked state, and the step of selecting the orientation of the layers before interlocking so that these opposites of these one sides of said first and second layer contacting each other when the layers are interlocked, to thereby avoid curling.

In an alternative embodiment (to be used separately or in combination with the embodiment just discussed) the method comprises a step of determining which side of the first and second layer has a less rough surface than the other side, and the step of selecting the orientation of the layers so that the roughest sides of said first and second layer contacting each other when the layers are interlocked, to thereby avoid marks on the glass.

A technique for the interlocking is based on needle punching said first and second layer.

In a further embodiment thereof said need punching is also being applied to the second layer being a fiber web.

### BRIEF DESCRIPTION OF THE DRAWINGS

FIG. 1 show a schematic use of the material as ring in glass processing.

FIG. 2 show a schematic of the material with at least one layer.

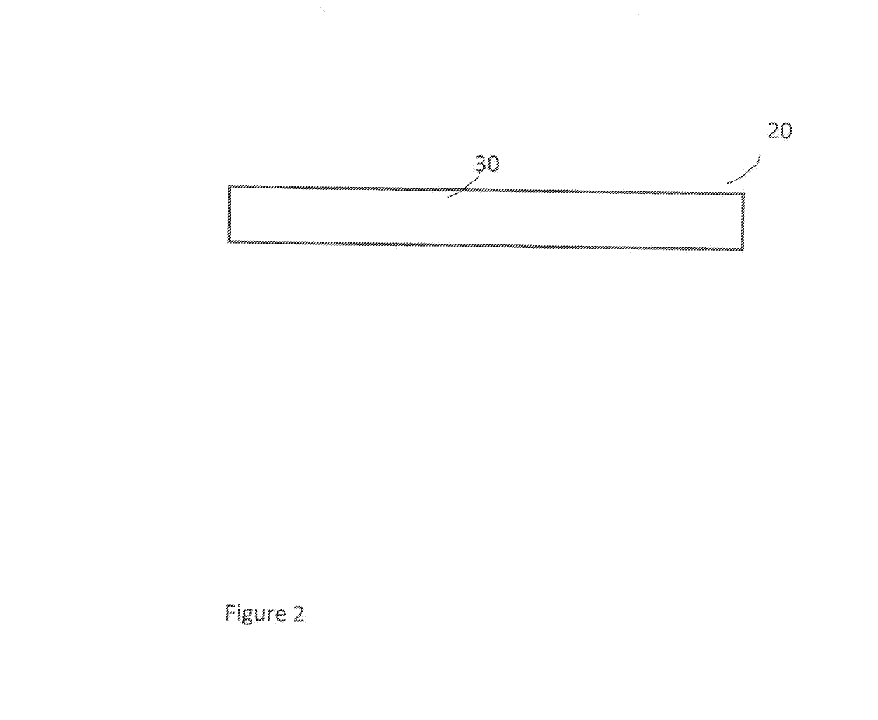

FIG. 3 shows a double layer structure with the non-curled portion and the curled portions (left of the dotted line).

FIG. 4 shows a triple layer structure with a web at the outer side.

FIG. 5 shows a triple layer structure with a web at the inner side.

FIG. 6 shows a fourth layer structure with a web at both the outer and inner side.

### DETAILED DESCRIPTION OF THE INVENTION

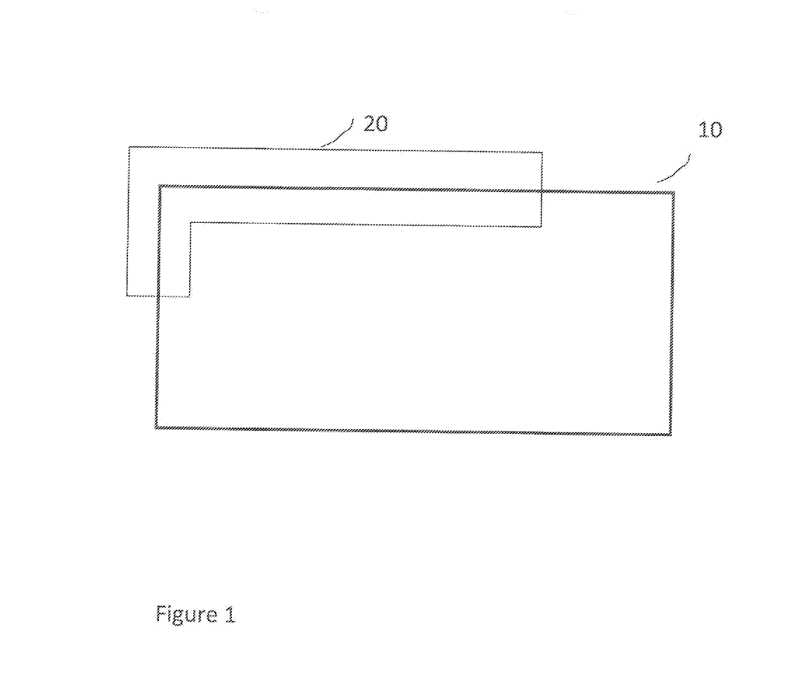

As discussed a material is selected or created by performing some adaptations such that curling can be avoided, such material being suitable as ring in glass processing as indicated in FIG. 1.

As will we described further the selection can be the purposely selection of a double bed (also called double jersey) approach or adding addition layers. In essence the recognition and solving of the curling problem for the applications as discussed, in particular by ensuring that at least a piece of the material (the size of such piece being arbitrarily large and at least large enough to enable its use in glass processing, especially for windshield for vehicles like cars), remains substantially flat (defined as flat enough to be suited in glass processing) if in rest (meaning not fixed by other means). Intrinsic this effect is achieved by the purposely balancing of internal forces within a double bed single layer or of a first layer with a second layer and various combinations thereof.

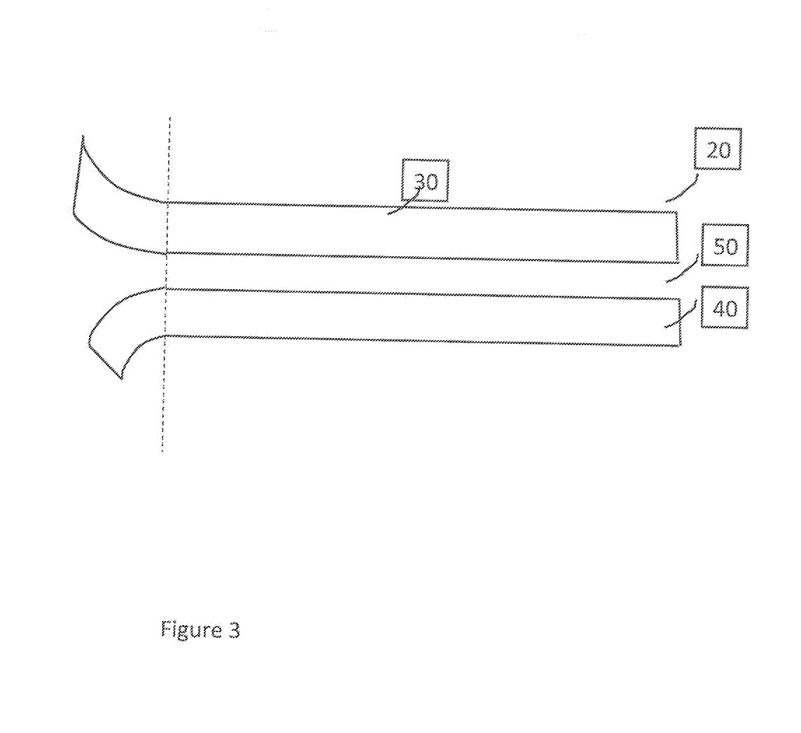

As a first example the new material contains two layers of a knitted fabric as shown in FIG. 3. The two layers (30) (40) are faced to each other with the right side of the structure, This will create opposite forces so that curling can be avoided. The layers are sealed (50). To seal the materials, a needle punch technology can be used. This will connect the two layers and creates a smooth surface. Characteristics of the new material are flexibility, the easy to form the corners, softness so no marking on the glass occurs, easy to mount such that adjustments and remounting is not necessary, a long lifetime because of the double structure and a cushion effect. FIG. 3 shown the working principle by indicating the curling of not connected sections or portions (60) (70).

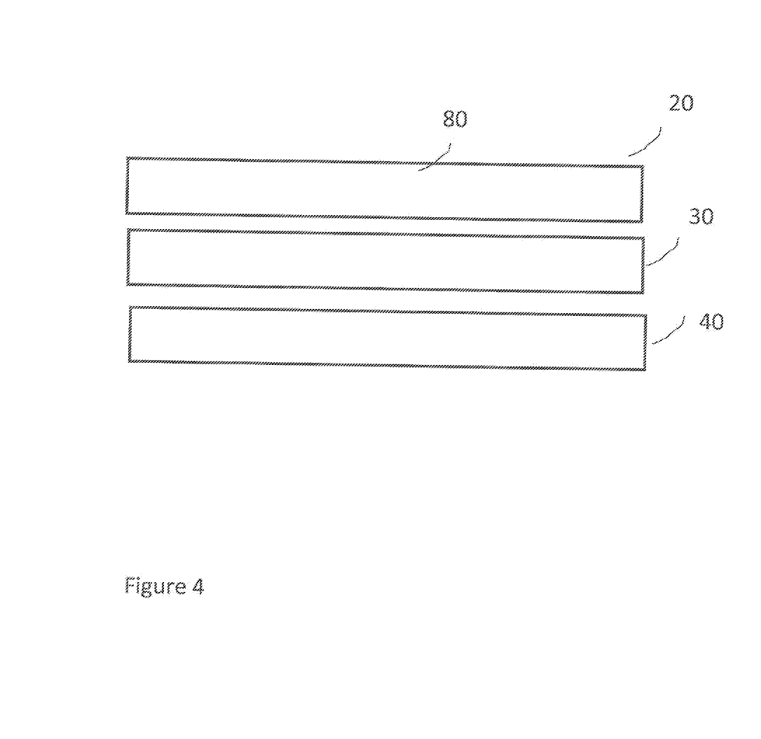

Optionally a layer (80) of fiber web or needle punched fibers is added on the surface that makes contact with the glass. FIG. 4 shows an example thereof.

Or a layer of fiber web or needle punched fibers in-between the two layers of knitted fabric is added to create a better contact between the two layers of knitted fabric.

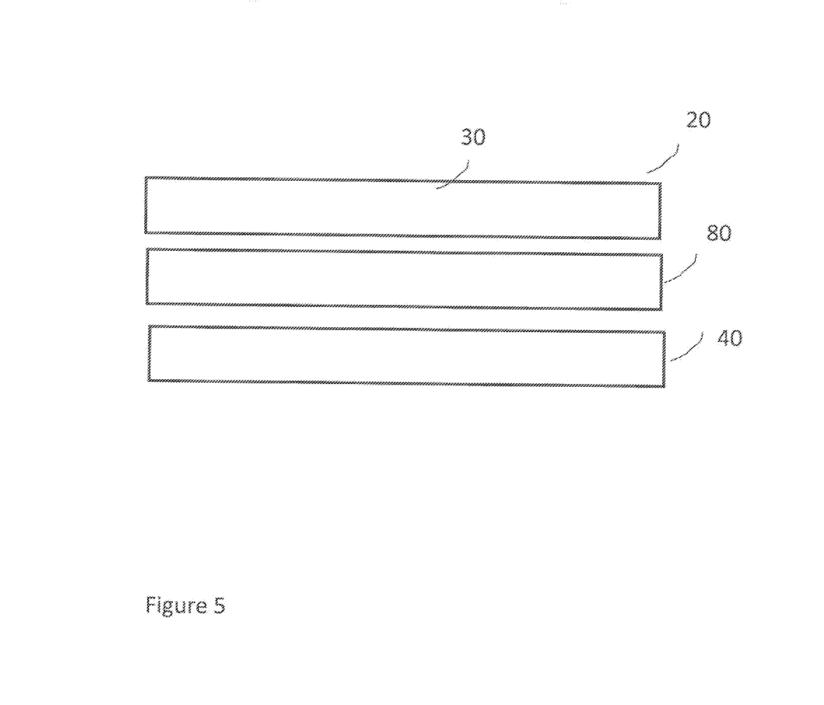

In a further option a woven scrim (80) in-between the two layers of knitted fabric is added to create more stability. FIG. 5 shows an example thereof.

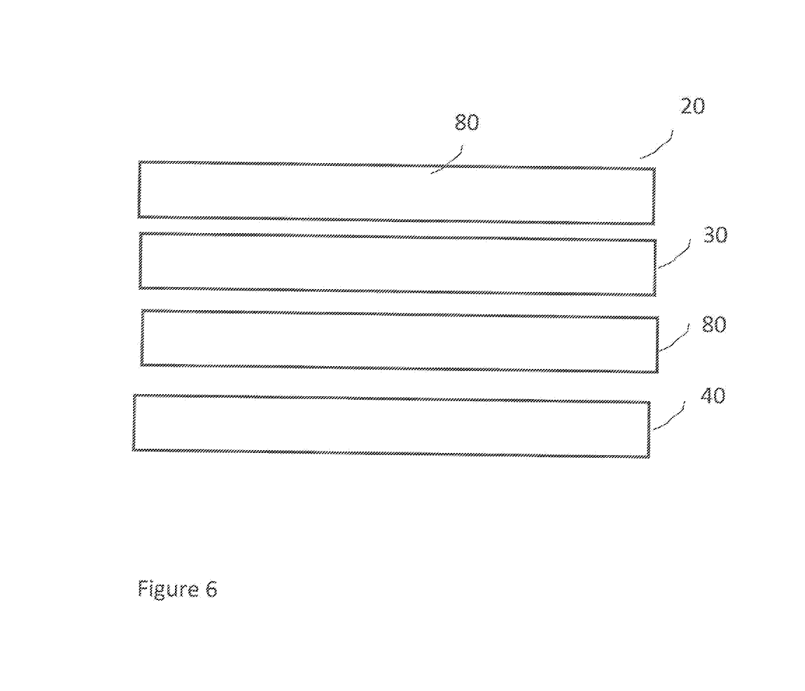

FIG. 6 shows a combination of the use of additional layer to result in a fourth layer material, wherein those additional layers are not necessarily the same.

Generally spoken the material is selected to have the property of avoiding curling, as in easy use in subsequent glass processing is aimed at, by facing layers with their right sides to create opposite forces so that curling can be avoided. Alternatively a double bed structure is used to achieve the same effect. Note that a double bed structure might be seen as a double (sub-) layer material also, being interconnected by the very start of its creation. While various techniques for creating double beds exists (with or without enabling (partial) separation of the (sub-) layers), the selection to be used here is again to avoid the curling.

Further to avoid marks on the glass, methods to create smooth surface is used either by selecting the smooth sides or use of sealing methods contributing thereto.

Note that besides needle punching as interlocking technique any other techniques such as glue, more in particular heat resistant glues (such as ceramic or silicon glues) or stitching such as with (stainless) steel yarns or wires or glass or ceramic yams or (para-) aramid (like Kevlar) or PBO (poly(p-phenylene-2,6-benzobisoxazole) yarns.

1. A material (20), so adapted to prevent curling, comprising a first knitted steel fiber layer (30).

2. The material of claim 1, comprising a second steel fiber layer (40), wherein said first and second fiber layer, being interlocked (50) to form the material.

3. The material of claim 2, wherein the second steel fiber layer is a knitted steel fiber layer.

4. The material of claim 2, wherein the second steel fiber layer is a fiber web layer.

5. The material of claim 2, wherein the second steel fiber layer is a needle-punched fiber layer.

6. The material of claim 2, wherein the second steel fiber layer is a woven steel fiber layer.

7. The material of claim 2, wherein one side of the first and second layer has a less rough surface than the other side thereof; and the orientation of the layers being so selected that the roughest sides of said first and second layer contacting each other when the layers are interlocked.

8. The material of claim 2, wherein said first and second layer are needle-punched together to form the material.

9. The material of claim 2, wherein the first layer in unlocked state (60) rolls up on one side in a first dimension and the second layer in unlocked state (70) rolls up in on one side in this same first dimension, the orientation of the layers being so selected that these opposites of these one sides of said first and second layer contacting each other when the layers are interlocked.

10. The material of claim 9, wherein the second steel fiber layer is a knitted steel fiber layer.

11. The material of clam 9, wherein the second steel fiber layer is a fiber web layer.

12. The material of claim 9, wherein the second steel fiber layer is a needle-punched fiber layer.

13. The material of claim 9, wherein the second steel fiber layer is a woven steel fiber layer.

14. The material of claims 9, wherein one side of the first and second layer has a less rough surface than the other side thereof; and the orientation of the layers being so selected that the roughest sides of said first and second layer contacting each other when the layers are interlocked.

15. The material of claim 9, wherein said first and second layer are needle-punched together to form the material.

16. The material of claim 1, wherein the first knitted steel fiber layer is a double jersey.

17. The material of claim I, wherein one or more of the steel fiber layer is made of stainless steel.

18. Use of the material according to claim 1, (laminate) glass processing, in particular windshield production.

19. A manufacturing method of a material, the material being so adapted that at least a piece of the material remains substantially flat in rest, the method comprising: the step of obtaining a first knitted steel fiber layer; the step of obtaining a second steel fiber layer; and a step of interlocking said first and second layer.

20. The method of claim 19, further comprising the step of determining on which side the first layer rolls up in unlocked state; the step of determining on which side the second layer rolls up in unlocked state; and the step of selecting the orientation of the layers before interlocking so that these opposites of these one sides of said first and second layer contacting each other when the layers are interlocked.

21. The method of claim 20, further comprising a step of determining which side of the first and second layer has a less rough surface than the other side; and the step of selecting the orientation of the layers so that the roughest sides of said first and second layer contacting each other when the layers are interlocked.

22. The method of claim 20, further comprising a step of determining which side of the first and second layer has a less rough surface than the other side; and the step of selecting the orientation of the layers so that the roughest sides of said first and second layer contacting each other when the layers are interlocked.

23. The method of claim 19, further comprising a step of determining which side of the first and second layer has a less rough surface than the other side; and the step of selecting the orientation of Inc layers so that the roughest sides of said first and second layer contacting each other when the layers are interlocked.

24. The method of claim 19, wherein the interlocking is based on needle punching said first and second layer.

25. The method of claim 19, wherein said needle punching also being applied to the second layer being a fiber web.
